(19) United States
(12) Patent Application Publication
(10) Pub. No.: US 2007/0213252 A1
(43) Pub. Date: Sep. 13, 2007

(54) Hard surface cleaning agent

(75) Inventors: Brian V. Sokol, Vermilion, OH (US); David A. Lupyan, Chagrin Falls, OH (US)

Correspondence Address: Fay, Sharpe, Fagan,;Minnich & McKee, LLP, 7th Floor, 1100 Superior Avenue, Cleveland, OH, 44114-2579, US

(73) Assignee: SimplyClean Industries LLC, an Ohio limited liability corporation

(21) Appl. No.: 11/453,477

(22) Filed: Jun. 14, 2006

Related U.S. Application Data
(60) Provisional application No. 60/762,640, filed on Jan. 27, 2006.
(60) Provisional application No. 60/778,690, filed on Mar. 3, 2006.

(51) Int. Cl. C11D 3/02

(52) U.S. Cl. 510/511

(57) ABSTRACT

A lubricating based cleaning composition for cleaning and protecting surfaces comprising silicone, wetting agent, and non-organic solvent.

The present invention claims priority on U.S. Provisional Patent Application Ser. Nos. 60/762,640 filed on Jan. 27, 2006 entitled “Water Free Cleaning Agents” and 60/778,690 filed Mar. 3, 2006 entitled “Hard Surface Cleaning Agent”, which are incorporated herein.

The present invention generally relates to a hard surface cleaning formula, more particularly to a hard surface cleaning formula that can be directly applied to a soiled surface so as to clean the soiled surface, and even more particularly to a hard surface cleaning formula that can be directly applied to a heavily soiled surface of a vehicle and which can remove dirt and grime from the vehicle surface without scratching any surface and form a clean, shiny and a smooth surface on the vehicle without having to first pre-wet and/or pre-wash the vehicle.

### BACKGROUND OF THE INVENTION

Cleaning agents for hard surfaces, such as for use in cleaning the outer painted surface of a vehicle, typically require large quantities of water to properly wet the surface prior to or during the application of the cleaning agent. Large quantities of water are normally used to remove larger and/or heavier particles and/or abrasive particles from the surface of the vehicle (e.g., salt, dirt, etc.) which could otherwise scratch highly polished automotive finishes. The water is used as a pre-wetting (e.g., lubricant, etc.) or cleaning material. Once the vehicle has been pre-wetted, a cleaning solution is typically applied to a vehicle to remove the remaining dirt and grime on the vehicle surface. After the surface of the vehicle has been cleaned, the surface is typically dried, and then a wax is applied to the dried surface to apply the final finish to the vehicle. The surface of the vehicle must be substantially free of foreign particles (e.g., dust, dirt, salt, etc.) prior to applying and rubbing the wax onto the surface of the vehicle; otherwise, the hard surface of the vehicle may be scratched. Large dirt particles (e.g., 100 microns or greater) on a hard surface of a vehicle can act as an abrasive that can scratch the painted surface if not completely removed before wiping the surface. Therefore, when traditionally washing a vehicle, large volumes of water are first used to rinse away larger poorly adhered dirt particles before applying a cleaning agent to the vehicle and wiping with a cloth or sponge.

Recent formulas for wax finishes allow a user to apply the wax to a wet, but clean surface, thereby eliminating the need to dry the vehicle surface prior to applying and rubbing the wax into the surface of the vehicle.

Although these new wax formulas have eliminated the step of pre-drying a vehicle surface after washing and prior to applying a wax finish, these new wax formulas, as with the more standard wax formulas, require the vehicle to be washed and cleaned before the wax is applied and rubbed into the surface of the vehicle so as to minimize the scratching of the painted surface of the vehicle. The need to pre-wash the vehicle with water is time consuming, and in some situations, impractical. Not every vehicle owner has easy or convenient access to a source of water for cleaning his/her vehicle. In densely populated areas, it is nearly impossible for an individual to personally wash his/her car. As such, these car owners have to travel to local car wash facilities, which facilities can be costly, time-consuming due to long lines, and/or inconvenient to access. In some arid regions, the use of water can be periodically limited, thereby preventing car owners from washing their car during a time of water rationing. In arctic regions, the temperature during the winter may be so low so as to prevent the use of an outside water facet and/or can result in the closing of local carwashes. In any one of the situations mentioned above, the car owner is unable to easily wash his/her car and apply a protective wax finish to the car surface.

In view of the current state of the prior art with regard to cleaning solutions for hard surfaces, especially for vehicle surfaces, there remains a need for a cleaning solution that can easily and conveniently remove dirt, salt and other undesired materials from a hard surface and which can form a shinny protective surface without scratching the hard surface and without having to pre-wash the hard surface with large qualities of water.

### SUMMARY OF THE INVENTION

The present invention relates to a novel hard surface cleaning formula, more particularly to a novel hard surface cleaning formula that can be directly applied to a soiled surface so as to clean the soiled surface, and even more particularly to a novel hard surface cleaning formula that can be directly applied to a soiled surface and which can remove the dirt and grime from the hard surface and form a clean and shiny surface on the hard surface without having to first wash the hard surface with water. The novel hard surface cleaning formula is particularly directed to painted hard surfaces such as, but not limited to vehicle painted exterior surfaces (e.g., car, truck, mobile homer, etc.); however, it will be appreciated that the hard surface cleaning formula can be used on many other or additional hard surfaces. Such other hard surfaces include, but are not limited to, bathroom surfaces (e.g., floor, tub, shower, mirror, toilet, bidet, bathroom fixtures, etc.), kitchen/washroom surfaces (e.g., counter tops [tile surfaces, granite or other stone surfaces, Corian®or other manmade hard surfaces, marble surfaces, wood surfaces, glass surfaces, etc.], stove, oven, range, sink, refrigerator, freezer, microwave, coffee maker, toaster, appliances, washing machine, dryer, iron, tables, chairs, cabinets, drawers, floors, etc.), furniture surfaces (e.g., tables, chairs, sofas, love seats, benches, beds, stools, armoires, chests, dressers, display cabinets, clocks, buffet, shades, shutters, entertainment centers, arm rails, lamps, banisters, libraries, cabinets, desks, doors, shelves, couches, beds, carts, pianos, statues and other art, mirrors, racks, fans, light fixtures, pool table, ping pong table, soccer table, card table, etc.), statues, windows, window ledges, tools, utility devices (e.g., telephones, radios, t.v., stereo equipment, CD and DVD players, analog and digital sound devices, palm computers, laptop computers, desktop and tower computers, computer monitors, etc.), bicycles, snowmobiles, motorcycles, off-road-vehicles, yard equipment, farm equipment, washing equipment (e.g., power washers, etc.), painting equipment (e.g., electric and air powered painting equipment, etc.), medical and/or dental equipment, marine equipment (e.g., sail boats, power boats, rafts, sail board, canoe, row boats, etc.), toys, writing implements, watches, and/or the like. The novel hard surface cleaning formula of the present invention represents a significant advance over prior hard surface cleaning solutions in that the novel hard surface cleaning formula of the present invention is formulated to clean heavily soiled surfaces without the need or use of a secondary water supply, and which novel hard surface cleaning formula can form a shinny and clean surface without concern of scratching the cleaned hard surface. As such, the novel hard surface cleaning formula of the present invention eliminates the need for a hard surface, such as a painted surface of a vehicle, so to be pre-washed with large qualities of water to remove large particles from the vehicle surface prior to applying another compound to the vehicle surface and rubbing such surface to form a shine on such surface. The novel hard surface cleaner is formulated to be applied to a hard surface, without having to pre-wash and/or pre-wet the hard surface, and then be wiped off the hard surface by use of a clean absorbent material (e.g., paper towel, cloth towel, etc.) so as to remove unwanted dirt, grime, etc. from the hard surface to also form a clean shine on the hard surface. The novel hard surface cleaning formula of the present invention includes one or more wetting agents that enable the novel hard surface cleaning formula loosen and/or lift particles from the hard surface so as to enable such particles to be easily and safely removed from the hard surface without damaging or scratching the hard surface. The novel hard surface cleaning formula of the present invention also includes one or more lubricating/protective agents that facilitating in forming a buffer layer between the particles and the hard surface. The buffer layer acts to at least partially protect the hard surface from being scratched by abrasive particles when the particles are removed from the hard surface by wiping the novel hard surface cleaner off the hard surface with a clean paper towel, cloth towel, rag, etc.

In one non-limiting aspect of the present invention, the novel hard surface cleaning formula of the present invention forms a shine on a hard surface without the use of a natural and/or synthetic wax. Many prior car polishes included one or more waxes to form a shine and protective coating on a previously cleaned surface. One of the popular waxes for car polishes is carnauba wax. The wax content in prior polishing and wax formulations typically required the user to forcefully rub the wax onto the surface of the vehicle. As a result, abrasive particles had to be removed from the surface of the vehicle prior to rubbing the wax onto the vehicle surface so as to avoid scratching of the vehicle surface. In one non-limiting formulation of the novel hard surface cleaning formula of the present invention, the formulation is absent or essentially absent natural and/or synthetic wax. The absence of wax from the novel hard surface cleaning formula of the present invention enables the formula to have a lower viscosity, which allows the novel hard surface cleaning formula to be 1) easily applied and removed from a hard surface, and/or 2) enables the novel hard surface cleaning formula to be spread over a larger surface area per volume as compared to higher viscosity formulas. In addition, the absence of wax from the novel hard surface cleaning formula of the present invention enables the formula to form a shine on the hard surface without having to exert large amounts of force by the user. In essence, the novel hard surface cleaning formula can be simply wiped off a hard surface and form a shiny and clean surface on the hard surface. Furthermore or alternatively, the absence of wax from the novel hard surface cleaning formula allows the novel hard surface cleaning formula to be used on glass surfaces without streaking. Wax based polishes can leave a noticeable film on glass surfaces that can be difficult to remove. The novel hard surface cleaning formula is formulated so that it can be easily removed from glass surfaces to provide an essentially streak-free surface on the glass.

In another and/or alternative non-limiting aspect of the present invention, the novel hard surface cleaning formula of the present invention includes silicone, wetting agent, lubricating agent and non-organic solvent. The silicone is at least partially used to form a protective layer on the surface of a hard surface. The silicone can also or alternatively be used to facilitate in forming a shine on the hard surface. The silicone can partially or fully function also as the lubricating agent for the novel hard surface cleaning formula. In one non-limiting embodiment of the invention, the silicone content of the novel hard surface cleaning formula is generally at least about 0.1 weight percent. In one non-limiting aspect of this embodiment, the silicone content of the novel hard surface cleaning formula is less than about 20 weight percent. In another and/or alternative non-limiting aspect of this embodiment, the silicone content of the novel hard surface cleaning formula is about 0.2-15 weight percent. In still another and/or alternative non-limiting aspect of this embodiment, the silicone content of the novel hard surface cleaning formula is about 0.5-10 weight percent. In yet another and/or alternative non-limiting aspect of this embodiment, the silicone content of the novel hard surface cleaning formula is about 1-5 weight percent. As can be appreciated, other weight percentage of the silicone in the novel hard surface cleaning formula can be used. In another and/or alternative non-limiting embodiment of the invention, the silicone in the novel hard surface cleaning formula includes silicone oil. One non-limiting type of silicone oil is Silicone Fluid 350 offered by General Electric. As can be appreciated, other or additional types of silicone can be used. In still another and/or alternative non-limiting embodiment of the invention, the average viscosity of the silicone that is added to the novel hard surface cleaning formula is less than about 2000 cps @ 25° C. The viscosity of the silicone is selected so as to not unduly increase the viscosity of the final novel hard surface cleaning formula. A too large of viscosity of the final novel hard surface cleaning formula can impair the ability of the formula to rapidly wet the soiled hard surface and/or increase the amount of work and time necessary to remove the novel hard surface cleaning formula from the hard surface. In one non-limiting aspect of this embodiment, the average viscosity of the silicone that is added to the novel hard surface cleaning formula is less than about 600 cps @ 25° C. In another and/or alternative non-limiting aspect of this embodiment, the average viscosity of the silicone that is added to the novel hard surface cleaning formula is less than about 500 cps @ 25° C. In still another and/or alternative non-limiting embodiment of the invention, the non-organic solvent constitutes up to about 97 weight percent of the novel hard surface cleaning formula. In one non-limiting aspect of this embodiment, the non-organic solvent constitutes about 40-95 weight percent of the novel hard surface cleaning formula. In another and/or alternative non-limiting aspect of this embodiment, the non-organic solvent constitutes about 60-95 weight percent of the novel hard surface cleaning formula. In still another and/or alternative non-limiting aspect of this embodiment, the non-organic solvent constitutes more than 80 weight percent to up to about 92 weight percent of the novel hard surface cleaning formula. In yet another and/or alternative non-limiting aspect of this embodiment, the non-organic solvent constitutes about 82-90 weight percent of the novel hard surface cleaning formula. As can be appreciated, other weight percentage of the non-organic solvent in the novel hard surface cleaning formula can be used. In yet another and/or alternative non-limiting embodiment of the invention, the non-organic solvent includes water. In one non-limiting aspect of this embodiment, the non-organic solvent constitutes a majority weight percent water. In another and/or alternative non-limiting aspect of this embodiment, the non-organic solvent constitutes at least about 80 weight percent water. The water included in the non-organic solvent can be deionized water, tap water, purified water, etc. In still yet another and/or alternative non-limiting embodiment of the invention, the lubricating agent other than silicone, when used, constitutes less than about 28 weight percent of the novel hard surface cleaning formula. The lubricating agent as described here is a compound other than silicone oil. As mentioned above, any silicone oil can function as a lubricating agent. The lubricating agent, like the silicone, is used to facilitate in the removal of the novel hard surface cleaning formula and to reduce in the incidence of scratching of the hard surface. The lubricating agent facilitates in forming a barrier surface on the hard surface that at least partially functions as a buffer or protective layer when the novel hard surface cleaning formula is removed from the surface of the hard surface by the use of an absorbent material. In one non-limiting aspect of this embodiment, the lubricating agent constitutes up to about 25 weight percent of the novel hard surface cleaning formula. In another and/or alternative non-limiting aspect of this embodiment, the lubricating agent constitutes about 0.1-15 weight percent of the novel hard surface cleaning formula. In another and/or alternative non-limiting aspect of this embodiment, the lubricating agent constitutes about 0.4-12 weight percent of the novel hard surface cleaning formula. In still another and/or alternative non-limiting aspect of this embodiment, the lubricating agent constitutes about 0.8-10.5 weight percent of the novel hard surface cleaning formula. As can be appreciated, other weight percentages of the lubricating agent can be used. In a further and/or alternative non-limiting embodiment of the invention, the lubricating agent can include, but is not limited to, one or more compounds such as mineral oils (e.g., light mineral oils, etc.), ester oils (e.g., natural ester oils, etc.), vegetable oils, fish oils, etc. In still a further and/or alternative non-limiting embodiment of the invention, the wetting agent constitutes at least about 0.01 weight percent of the novel hard surface cleaning formula. The wetting agent is used to at least partially breakup and lift off dirt, grime, salt and other foreign material from the surface of the hard surface so that when the novel hard surface cleaning formula is wiped off by an absorbent material, the dirt, grime, etc. are removed from the hard surface. In one non-limiting aspect of this embodiment, the wetting agent constitutes about 0.04-5 weight percent of the novel hard surface cleaning formula. In another and/or alternative non-limiting aspect of this embodiment, the wetting agent constitutes about 0.1-3 weight percent of the novel hard surface cleaning formula. In still another and/or alternative non-limiting aspect of this embodiment, the wetting agent constitutes about 0.2-1.8 weight percent of the novel hard surface cleaning formula. As can be appreciated, other weight percentages of the wetting agent can be used. In yet another and/or alternative non-limiting aspect of this embodiment, one non-limiting wetting agent includes EB glycol ether and/or EW-20: however, other or additional wetting agents can be used.

In still another and/or alternative non-limiting aspect of the present invention, the novel hard surface cleaning formula of the present invention can include one or more other components such as, but not limited to, acids, neutralizers (e.g., pH buffers, etc.), biocide, fragrances, UV protectors, thickeners, fluoropolymer, colorants, preservatives, etc.

In yet another and/or alternative non-limiting aspect of the present invention, the novel hard surface cleaning formula of the present invention can be applied by conventional means to a hard surface to be cleaned. Such conventional means include, but are not limited to, a spray bottle with a sprayer, etc. In one non-limiting aspect of the present invention, the composition and viscosity of the novel hard surface cleaning formula of the present invention can be selected to enable the novel hard surface cleaning formula to be dispensed by conventional hand sprayers.

In still yet another and/or alternative non-limiting aspect of the present invention, the novel hard surface cleaning formula of the present invention can be applied to a hard surface in a generally continuous matter and at a generally constant force by use of an electric and/or air power spray dispenser. The application of the novel hard surface cleaning formula on a hard surface at a generally constant force enables the novel hard surface cleaning formula to be more uniformly applied to the hard surface, thereby improving the wetting of the surface by the novel hard surface cleaning formula. The improved wetting by the novel hard surface cleaning formula can result in increased speed at which the novel hard surface cleaning formula lifts and/or dislodges dirt, grime, etc. from the hard surface, thereby decreasing the residency time needed for the novel hard surface cleaning formula to be of the hard surface to properly clean the hard surface. The use of a dispenser that can constantly dispense the novel hard surface cleaning formula on a hard surface also allows the user to quickly cover a larger surface (e.g., complete surface of a vehicle, etc.) in a short period of time. Non-limiting examples of electric spray dispensers that can be used are disclosed in U.S. Pat. Nos. 5,716,007; 5,716,008 and 6,981,658, all of which are incorporated herein by reference.

One non-limiting object of the present invention is the provision of a novel hard surface cleaning formula and method for using the novel hard surface cleaning formula which enables a user to clean and shine a hard surface without having the pre-wet or pre-wash the hard surface with water or with water and cleaning solution.

Another and/or alternative non-limiting object of the present invention is the provision of a novel hard surface cleaning formula that does not require wax to form a shine on a hard surface.

Still another and/or alternative non-limiting object of the present invention is the provision of a novel hard surface cleaning formula that utilizes pre-wetting and lubricating mechanisms to clean a hard surface and to minimize scratching of the hard surface.

Yet another and/or alternative non-limiting object of the present invention is the provision of a novel hard surface cleaning formula that includes silicone, wetting agent, and non-organic solvent.

Still yet another and/or alternative non-limiting object of the present invention is the provision of a novel hard surface cleaning formula that can be dispensed on a hard surface by conventional spray mechanisms.

These and other advantages will become apparent to those skilled in the art upon the reading and following of this description taken together with the accompanying drawings.

### BRIEF DESCRIPTION OF THE DRAWINGS

Reference may now be made to the drawings, which illustrate various embodiments that the invention may take in physical form and in certain parts and arrangements of parts wherein:

FIGS. 1-5 illustrate a non-limiting spray dispenser that can be used to apply the novel hard surface cleaning formula to a hard surface.

### DETAILED DESCRIPTION OF THE INVENTION

The present invention relates to cleaning formulas for use in cleaning heavily soiled hard surfaces without the use of a water rinse step or a water and detergent cleaning step, and in particular to a hard surface cleaning formula for cleaning and polishing the exterior paint and trim, and/or tires of a vehicle. The novel hard surface cleaning formula of the present invention does not require the surface of a vehicle to be pre-washed with water or with water and a cleaning solution prior to the use of the novel hard surface cleaning formula. This is a significant improvement over prior polishing formulas. The novel hard surface cleaning formula enables a user in a two-step method to 1) apply the novel hard surface cleaning formula directly on the outer surface of a vehicle, generally by some spray mechanism, and then 2) wipe the novel hard surface cleaning formula off the vehicle with a clean absorbent material to obtain a clean and polished surface. The novel hard surface cleaning formula is formulated to obtain the clean and polished surface in a quick and easy manner without concern for scratching or otherwise damaging the surface of the vehicle. The novel hard surface cleaning formula is formulated to enable the user to safely apply the novel hard surface cleaning formula to tires, plastic trim, chrome surfaces, painted surfaces, glass mirrors and windows, etc., and to obtain a clean surface after merely wiping the novel hard surface cleaning formula off the vehicle with a clean absorbent material. Although the invention will be particularly described with reference to the cleaning of the exterior surface of a vehicle with the novel hard surface cleaning formula, it will be appreciated that the interior surface of the vehicle (e.g., leather seats, vinyl seats, wood trim, plastic dashboard, LCD screens, steering wheel, foot pedals, floor mats, stick shift, etc.) can also be cleaned and polished by the novel hard surface cleaning formula of the present invention. Furthermore, it will be appreciated that the novel hard surface cleaning formula can be used on hard surfaces other than on and/or in a vehicle.

The novel hard surface cleaning formula includes three principal components, namely silicone, wetting agent, and non-organic solvent. Generally, the novel hard surface cleaning formula also includes a lubricating agent. One non-limiting general formulation of the novel hard surface cleaning formula in weight percent is as follows:

| | |
|---|---|
| Silicone | 0.1–20% |
| Lubricating Agent | 0–25%. |
| Non-Organic Solvent | 40–97% |
| Wetting Agent | 0.01–5% |

A more specific formulation of the novel hard surface cleaning formula in weight percent is as follows:

| | |
|---|---|
| Silicone | 0.5–15% |
| Lubricating Agent | 0.2–15%. |
| Non-Organic Solvent | 60–95% |
| Wetting Agent | 0.1–3.5% |

An even more specific formulation of the novel hard surface cleaning formula in weight percent is as follows:

| | |
|---|---|
| Silicone | 1–5% |
| Lubricating Agent | 0.5–12%. |
| Non-Organic Solvent | 81–92% |
| Wetting Agent | 0.15–1.75% |

In addition to the primary components of the novel hard surface cleaning formula, the novel hard surface cleaning formula can include one or more additional components such as, but not limited to, acids, bases, biocide, colorants, detergents or grease cutters, fluoropolymer, fragrances, neutralizers, organic solvents, preservatives, thickeners, UV protectors, wax, etc.

An explanation of the known or believed functions of the components of the novel hard surface cleaning formula are set forth below; however, it will be appreciated that one or more of the components described below may have other or alternative functions.

Silicone: The silicone in the novel hard surface cleaning formula is used to at least partially form a protective layer on the hard surface. The silicone also at least partially acts a lubricant to facilitate in forming a slick and smooth protective layer on the hard surface. After the novel hard surface cleaning formula has been at least partially wiped off the hard surface by the use of an absorbent towel or the like, a thin layer of silicone remains on the hard surface. This silicone layer can be further shined by use of a micro-fiber cloth or the like to create an enhanced shine on the hard surface; however, this is not required. The silicone can also form a lubricating buffer layer between the hard surface to at least partially loosened dirt, grim, etc. so as to at least partially protect the hard surface from being scratch when the hard surface cleaning formula is wiped off the hard surface by the use of an absorbent towel or the like. One non-limiting type of silicone that can be used includes a silicone fluid or oil that has a viscosity of less than about 800 cps @ 25° C. 350 Silicon Fluid is a non-limiting type of silicone oil available from General Electric that can be used in the novel hard surface cleaning formula. Polydimethylsiloxane resin can also be included in the silicone fluid; however, it should be appreciated that other or additional silicone can be used.

Lubricating Agent: The lubricating agent in the novel hard surface cleaning formula is used to facilitate in the removal of the novel hard surface cleaning formula and to reduce in the incidence of scratching of the hard surface. The lubricating agent is believed to form a barrier surface on the hard surface that functions as a buffer or protective layer when the novel hard surface cleaning formula is removed from the surface of the hard surface by the use of an absorbent material. The lubricating agent may also work with the wetting agent to facilitate in loosening and/or lifting dirt, grime, etc. from the surface of the hard surface. As mentioned above, silicone can function as a lubricant in the novel hard surface cleaning formula. The term lubricating agent as used herein is a component in the novel hard surface cleaning formula other than silicone. Non-limiting examples of lubricating agents that can be used in the novel hard surface cleaning formula include mineral oil (e.g., natural ester oils, fish oils, various hydrocarbon-based saturated or unsaturated compounds, etc.), glycerin, kerosene, cyclohexane, heptane, and mixtures thereof; however, it should be appreciated that other or additional lubricating agents can be used. The viscosity of the lubricating agent is selected, like the silicone, so as to not unduly increase the viscosity of the final novel hard surface cleaning formula. A too large of viscosity of the final novel hard surface cleaning formula can impair the ability of the formula to rapidly wet the soiled hard surface and/or increase the amount of work and time necessary to remove the novel hard surface cleaning formula from the hard surface.

Non-Organic Solvent: The novel hard surface cleaning formula includes a significant portion of non-organic solvent. Typically the non-organic solvent is or includes water. In many formulations of the novel hard surface cleaning formula, the non-organic solvent constitutes a majority weight percent of the novel hard surface cleaning formula. In some formulations of the novel hard surface cleaning formula, the non-organic solvent constitutes at least about 82 weight percent of the novel hard surface cleaning formula.

Wetting Agent: The wetting agent is used to breakup and lift dirt, grime, salt and other foreign material off of the surface of the hard surface. Non-limiting examples of wetting agents include EB glycol ether, N-Octly Pyrrollidone, N-Methyl Pyrrollidine, many types of anionic and/or non-ionic surfactants, and mixtures thereof; however, it should be appreciated that other or additional wetting agents can be used.

In addition to these components of the novel hard surface cleaning formula, one or more additional of the following components can be included in the formula. The addition of these optional components to certain embodiments of the present invention may increase the appeal of the composition by bolstering the compositions' ability to clean and protect applicable surfaces, improve the look, feel, and/or smell of the compositions, etc.

Biocides/Preservatives: One or more biocides and/or preservatives can be included in the novel hard surface cleaning formula. The one or more biocides and/or preservatives, when used, can extend the life of the novel hard surface cleaning formula and/or to maintain the integrity of one or more components of the novel hard surface cleaning formula. The novel hard surface cleaning formula can include up to about 1.5 wt % biocides and/or preservatives, typically about 0.01-1 wt % biocides and/or preservatives, more typically about 0.02-0.5 wt % biocides and/or preservatives, and even more typically about 0.04-0.4 wt % biocides and/or preservatives. Non-limiting examples of biocides and/or preservatives that can be used include, but are not limited to, Nuosept C™, Nuosept-95™, and Kathon; however, it should be appreciated that other or additional biocides and/or preservatives can be used.

Detergents/Grease Cutters: One or more detergents and/or grease cutter can be included in the novel hard surface cleaning formula. The detergents and/or grease cutters, when used, can be used to facilitate in breaking up and/or lifting off of foreign materials from the hard surface so as to ease in the removal of such foreign substances. The novel hard surface cleaning formula can include up to about 1.5 wt % detergents and/or grease cutters, typically about 0.01-1 wt % detergents and/or grease cutter, more typically about 0.1-0.8 wt % detergents and/or grease cutters, and even more typically about 0.2-0.5 wt % detergents and/or grease cutters. One non-limiting example of a grease cutter is butyl-cellosolve glycol ether; however, it should be appreciated that other or additional detergents and/or grease cutters can be used. It is noted that many types of wetting agents also have the function of acting as detergents/grease cutters. Likewise, the organic solvent, when used, can act as a grease cutter.

Fluoropolymer: One or more fluoropolymers can be included in the novel hard surface cleaning formula. The fluoropolymers, when used, are generally used to extend the life of the silicone protective layer on the hard surface. The fluoropolymers, when used, can also function as wetting agents. The fluoropolymers, when used, can be present in the novel hard surface cleaning formula amounts up to about 2% by weight of the novel hard surface cleaning formula, and typically about 0.01-1% by weight. Non-limiting examples of fluoropolymers that can be used include, but are not limited to, polytetrafluoroethylene (e.g., MP1150, etc.), perfluoroalkyl methacrylic copolymer (e.g., Zonyl 8740, Zonyl 8607, etc.); however, it should be appreciated that other or additional fluoropolymers can be used.

Fragrances/Colorants: One or more fragrances and/or colorants can be included in the novel hard surface cleaning formula. The fragrances and/or colorants, when used, are generally used to provide a desired scent to the novel hard surface cleaning formula, to mask undesired scents of one or more of the components of the novel hard surface cleaning formula, and/or to provide a desired color for the novel hard surface cleaning formula. The fragrances and/or colorants, when used, can be present in the novel hard surface cleaning formula amounts up to about 1.5% by weight of the novel hard surface cleaning formula, typically about 0.001-0.8% by weight, more typically about 0.05-0.4% by weight, and even more typically about 0.07-0.15% by weight.

Hydrophobic polymers and/or hydrophilic agents: One or more hydrophobic polymers and/or hydrophilic agents can be included in the novel hard surface cleaning formula. The hydrophobic polymers and/or hydrophilic agents, when used, can facilitate in the breaking up and/or lifting off of foreign materials from the hard surface so as to ease in the removal of such foreign substances, provide additional protection to the hard surface, and/or enhance the shine on the hard surface. The novel hard surface cleaning formula can include up to about 4 wt % hydrophobic polymers and/or hydrophilic agents, typically about 0.01-3 wt % hydrophobic polymers and/or hydrophilic agents, more typically about 0.2-2 wt % hydrophobic polymers and/or hydrophilic agents, and even more typically about 0.5-1.5 wt % hydrophobic polymers and/or hydrophilic agents. Non-limiting general examples of hydrophobic polymers that can be used include, but are not limited to, waxes (e.g., Aqua-bead 916® and Ceridust 9639 F®, carnauba wax, etc.), siloxanes, etc.; however, it should be appreciated that other or additional hydrophobic polymers and/or hydrophilic agents can be used.

Organic Solvent: One or more organic solvents can be included in the novel hard surface cleaning formula. The organic solvent, when used, can facilitate in carrying lubricants in the non-organic solvent. The organic solvent can also be used to facilitate in the cleaning of organic foreign materials (e.g., road tar, tree sap, bird droppings, inserts, etc.) on the hard surface that is being cleaned. The novel hard surface cleaning formula can include up to about 25 wt % organic solvent, typically about 0.1-20 wt % organic solvent, more typically about 2-15 wt % organic solvent, and even more typically about 6-12 wt % organic solvent. Non-limiting general examples of organic solvents that can be used include, but are not limited to, Isopar M®, Isopar L®, and Isopar G®.

pH buffers: One or more pH buffers can be included in the novel hard surface cleaning formula. The pH buffer, when used, can be used to adjust the pH of the novel hard surface cleaning formula. The pH buffer can include one or more acids, bases, neutralizers, etc. The novel hard surface cleaning formula can include up to about 5 wt % pH buffer, typically about 0.01-4 wt % pH buffer, more typically about 0.05-3 wt % pH buffer, and even more typically about 0.1-1 wt % pH buffer. Non-limiting examples of pH buffers that can be included in the novel hard surface cleaning formula include, but are not limited to, triethanol-amine, mono-isopropanolamine, diisopropanolamine, and morpholine; however, it should be appreciated that other or additional pH buffer can be used.

Silicon emulsions: One or more silicon emulsions can be included in the novel hard surface cleaning formula. The silicon emulsions, when used, provide for further lubrication of the novel hard surface cleaning formula to facilitate in the removal of the novel hard surface cleaning formula from a hard surface and/or to facilitate in the spreading of the novel hard surface cleaning formula on a hard surface. The silicon emulsions, when used, can be present in the novel hard surface cleaning formula amounts up to about 6% by weight of the novel hard surface cleaning formula, typically about 0.01-4% by weight, more typically about 0.2-2% by weight, and even more typically about 0.5-1.4% by weight. Non-limiting example of silicon emulsions that can be used include, but are not limited to, SM 2163 Silicone Emulsion®, and SEM 206; however, it should be appreciated that other or additional silicon emulsions can be used.

Surfactant: One or more surfactants can be included in the novel hard surface cleaning formula. When surfactant is included in the novel hard surface cleaning formula, the surfactant is present in amounts of up to about 5% by weight of the novel hard surface cleaning formula, typically about 0.01-3% by weight, more typically about 0.05-2.5% by weight, even more typically about 0.1-2% by weight, and still even more typically about 0.2-0.8% by weight. Non-limiting examples of surfactant that maybe utilized in the novel hard surface cleaning formula include tall oil fatty acid (e.g., TOFA, XTOL Tall Oil, etc.), polysiloxane polyethylene glycol copolymer silicone surfactant; however, it should be appreciated that other or additional surfactant can be used. The surfactant can also function as a wetting agent.

Thickening Agent: One or more thickening agents may be utilized in varied amounts to increase the viscosity as well as stabilize the composition of the creamy homogeneous emulsion. Some types of thickener can also function as lubricating agents. The thickening agent, when used, can be present in the novel hard surface cleaning formula amounts up to about 2% by weight of the novel hard surface cleaning formula, typically about 0.01-0.75% by weight, more typically about 0.05-0.5% by weight, and even more typically about 0.1-0.4% by weight. Non-limiting examples of thickening agents include Poly Gel DR®, salts of polyacrylic acid polymers, hydroxyethyl cellulose, cellulose gums, xanthan gums, magnesium aluminum silicate, and/or natural polysaccharides; however, it should be appreciated that other or additional thickening agents can be used.

UV Protectants: One or more UV protectants can be included in the novel hard surface cleaning formula. The UV protectants, when used, are generally used to provide additional protection to certain hard surfaces that can be damaged and/or discolored by UV light (e.g., plastic, vinyl, etc.). The UV protectant, when used, can be present in the novel hard surface cleaning formula amounts up to about 1.5% by weight of the novel hard surface cleaning formula, typically about 0.01-0.8% by weight, more typically about 0.05-0.3% by weight, and even more typically about 0.07-0.2% by weight. Non-limiting examples of UV protectant that can be used include, but are not limited to, Tinuvin 99® and Tinuvin 1130®; however, it should be appreciated that other or additional UV protectant can be used.

The novel hard surface cleaning formula of the present invention generally has a basic pH. Typically the pH of the novel hard surface cleaning formula is about 7.5-12, and more typically about 7.5-11, and even more typically about 8-10. The novel hard surface cleaning formula has a generally homogenous milky or creamy white viscous liquid appearance, unless a colorant is added to the novel hard surface cleaning formula. The viscosity of the novel hard surface cleaning formula is generally at least about 200 cps as measured by a Brookfield viscometer @25° C., typically less than about 3000 cps @25° C., more typically about 300-2500 cps @ 25° C., even more typically about 400-2300 cps @ 25° C., and still even more typically about 800-2100 cps @ 25° C.

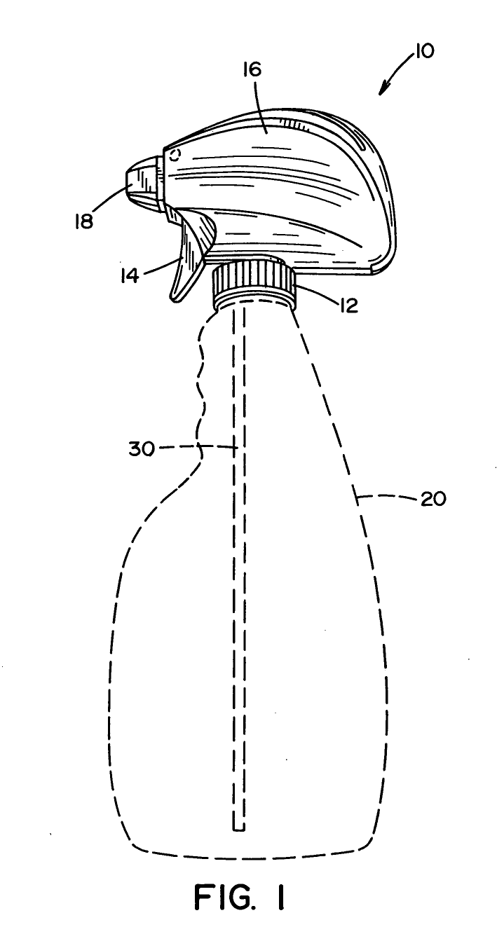

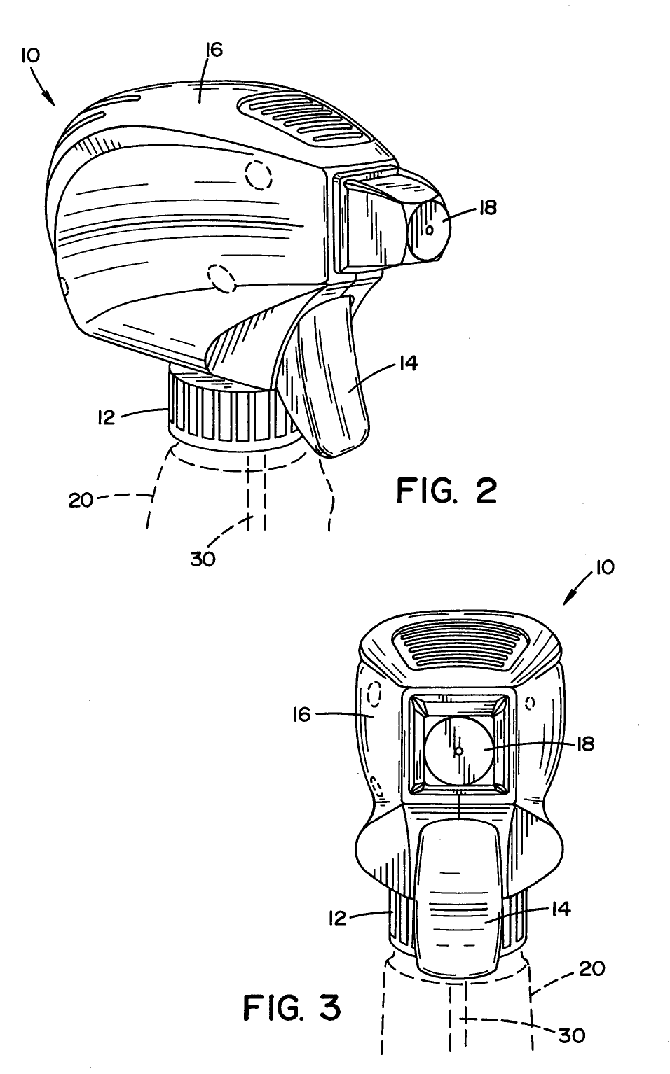

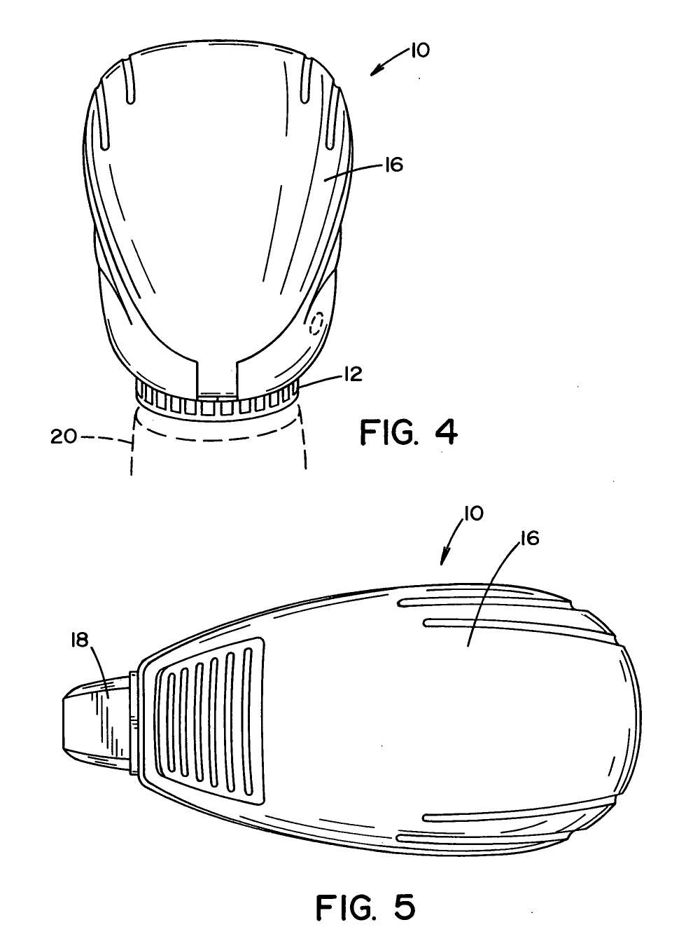

The novel hard surface cleaning formula of the present invention is formulated to be applied to a moderate to highly dirty surface through various application methods. As can be appreciated, the novel hard surface cleaning formula of the present invention can also be applied to light soiled surfaces. As mention above, the novel hard surface cleaning formula of the present invention can be applied directly to a soiled surface without having to first pre-wet or pre-wash the hard surface. Non-limiting examples of methods of applying the novel hard surface cleaning formula to a hard surface includes spraying or wiping the composition onto a surface; however, it should be obvious to one skilled in the art that other or additional application methods may be employed. In one non-limiting application method, the novel hard surface cleaning formula of the present invention is applied to a hard surface such as the exterior of a vehicle by use of a manual powered (e.g., hand pump sprayer, etc.), motorized sprayer and/or air pump sprayer apparatus (e.g., electric sprayer, etc.). Manual pump sprayer apparatuses are of the type that are commonly utilized to apply liquid cleaning products. The use of a motorized and/or air pump sprayer apparatus can be used to 1) more uniformly apply the novel hard surface cleaning formula to a hard surface, 2) more rapidly apply the novel hard surface cleaning formula to a hard surface, and/or 3) forcefully apply the novel hard surface cleaning formula to a hard surface so as to increase the rate of wetting and/or penetration of the novel hard surface cleaning formula onto a soil surface. A non-limiting example of an electric powered sprayer that can be used to apply the novel hard surface cleaning formula onto a soil surface is illustrated in FIGS. 1-5. Electric sprayer 10 is a battery operated sprayer. The base of the sprayer includes a threaded connector 12 that is used to connect to a bottle 20 as illustrated by the dotted lines. In practice, bottle 20 is at least partially filled with the novel hard surface cleaning solution. Thereafter, electric sprayer 10 is connected to the top of the bottle via connector 12. A hollow tube 30 is used to feed the novel hard surface cleaning solution in the bottle to electric sprayer 10. When a user is prepared to apply the novel hard surface cleaning solution onto a hard surface, the user pulls back trigger 14. The pulling of the trigger by the user causes the electric motor, not shown, in the housing 16 of the electric sprayer to draw the novel hard surface cleaning solution through tube 30 and expel the novel hard surface cleaning solution through a nozzle 18. The nozzle can be adjustable to control the spray pattern of the novel hard surface cleaning solution exiting the nozzle; however, this is not required. The nozzle can be designed to shut-off the flow of the novel hard surface cleaning solution through the nozzle; however, this is not required. The housing 16 of the sprayer can include a battery compartment; not shown, to enable a user to replace the batteries in the spray; however, this is not required.

Once the novel hard surface cleaning formula has been applied to a hard surface, the novel hard surface cleaning formula begins wetting the dirt, grime etc. on the hard surface, breaking up the dirt, grime etc. on the hard surface, and lifting off the dirt, grime etc. from the hard surface, and/or at least partially encapsulate the dirt, grime etc. on the hard surface. The silicone, emulsifiers, and lubricating agents in the novel hard surface cleaning formula enable the dirt, grime etc. on the hard surface to be easily wiped from the hard surface by use of a clean absorbent towel, cloth, sponge, etc. The silicone and lubricating agents in the novel hard surface cleaning formula also inhibit or prevent the scratching of the hard surface as the dirt, grime etc. on the hard surface is wiped off by the clean absorbent material. After the novel hard surface cleaning formula has been applied to a hard surface, the user is not required to wait extended periods of time prior to being able to remove the novel hard surface cleaning formula from the hard surface. Generally the period of time to wait before the user can begin removing the novel hard surface cleaning formula from the hard surface is at least about 1 second, typically less than about 5 minutes, and more typically less than about 2 minutes.

The use of novel hard surface cleaning formula of the present invention eliminates the need of a user to pre-wet or to pre-wash a hard surface before using the novel hard surface cleaning formula. The need to pre-wet or to pre-wash a hard surface so as to remove particles that can potentially scratch a hard surface and/or to pre-wet the hard surface to provide a lubricating film on the hard surface is eliminated by the use of novel hard surface cleaning formula of the present invention. The novel hard surface cleaning formula enables a user in a two-step process, namely 1) apply the novel hard surface cleaning formula to a hard surface and 2) wipe off novel hard surface cleaning formula from the hard surface by use of a clean absorbent material, thereby easily and conveniently cleaning and polishing a hard surface without concern of scratching or otherwise damaging the hard surface. This simple two-step process does not require a separate water source. The complete formula to achieve the two-step cleaning process is fully contained in the novel hard surface cleaning formula of the present invention. No final rinsing of the hard surface is required. An increased shine on the hard surface can be obtained, if desired, by further wiping the cleaned hard surface by a micro-fiber cloth or the like.

The following examples of the novel hard surface cleaning formula are given for purposes of illustration only and are not to be interpreted as necessarily limiting the invention. All percentages are by weight unless otherwise indicated.

### EXAMPLE 1

| COMPONENT | COMPONENT | WT. % | SPECIFIC |
|---|---|---|---|
| NAME | DESCRIPTION | RANGE | WT % |
| Isopar L | Organic Solvent | 8–15% | 9.75–10% |
| 350 Silicone Fluid | Silicone | 2–5% | 2.8–3% |
| TOFA | Surfactant/ | 0.05–0.7% | 0.1–0.4% |
| | Wetting Agent | | |
| Poly Gel DR | Thickening | 0.005–0.5% | 0.1–0.12% |
| | Agent/ | | |
| | Lubricating Agent | | |
| Water | Non-Organic | 80.5–91% | 84–85.52% |
| | Solvent | | |
| Di- | pH Buffer | 0.2–0.7% | 0.35–0.4% |
| isopropanolamine | | | |
| SEM 206 | Silicon | 0.4–1.5% | 0.88–0.9% |
| | Emulsion/ | | |
| | Lubricating Agent | | |
| EW-20 | Wetting Agent | 0.03–0.25% | 0.08–0.1% |
| EB Glycol Ether | Wetting Agent | 0.2–1.5% | 0.8–0.9% |
| Nuocept-95 or | Biocide | 0.02–0.4% | 0.05–0.2% |
| Kathon | | | |
| Fresh Laundry or | Fragrance | 0.02–0.4% | 0.08–0.1% |
| Cherry Fragrance | | | |
| Carmarine Red Dye | Colorant | As needed | As needed |

### EXAMPLE 2

| COMPONENT | COMPONENT | WT. % | SPECIFIC |
|---|---|---|---|
| NAME | DESCRIPTION | RANGE | WT % |
| Isopar L | Organic Solvent | 6–10% | 7.75% |
| 350 Silicone Fluid | Silicone | 2–5% | 3% |
| XTOL Tall Oil | Surfactant/ | 0.2–0.7% | 0.4% |
| | Wetting Agent | | |
| Poly Gel DR | Thickening | 0.075–0.5% | 0.2% |
| | Agent/ | | |
| | Lubricating Agent | | |
| Water | Non-Organic Solvent | 82–92% | 86.25% |
| Di- | pH Buffer | 0.2–0.7% | 0.4% |
| isopropanolamine | | | |
| SEM 206 | Silicon | 0.4–1.4% | 0.8% |
| | Emulsion/ | | |
| | Lubricating Agent | | |
| EW-20 | Wetting Agent | 0.03–0.25% | 0.1% |
| EB Glycol Ether | Wetting Agent | 0.2–1.5% | 0.8% |
| Nuocept-95 | Biocide | 0.08–0.4% | 0.2% |
| Cherry | Fragrance | 0.02–0.4% | 0.1% |

In each of the specific weight percentages of the novel hard surface cleaning formula of Examples 1 and 2, the pH is about 8-10, the viscosity is about 1200-2500 cps measured by Brookfield viscometer @ 25° C. (#4 spindle @ 20 rpm). The appearance of the novel hard surface cleaning formula has a homogeneous creamy appearance. The novel hard surface cleaning formula is a pourable liquid. The color of the novel hard surface cleaning formula is creamy white. The odor of the novel hard surface cleaning formula is clean with no trace of amine odor. The weight per gallon of the novel hard surface cleaning formula is about 7-8 lbs/gal.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

1. A lubricating based cleaning composition for cleaning and protecting surfaces comprising silicone, wetting agent and non-organic solvent.

2. The cleaning composition as defined in clam 1, wherein said cleaning composition is absent wax.

3. The cleaning composition as defined in claim 1, including a lubricating agent other than silicone.

4. The cleaning composition as defined in claim 2, including a lubricating agent other than silicone.

5. The cleaning composition as defined in claim 1, wherein said non-organic solvent includes water, sand water present in an amount of over 80 weight percent of said cleaning composition.

6. The cleaning composition as defined in claim 4, wherein said non-organic solvent includes water, said water present in an amount of over 80 weight percent of said cleaning composition.

7. The cleaning composition as defined in claim 1, comprising by weight percent:

| | |
|---|---|
| Silicone | 0.1-20% |
| Lubricating Agent | 0-25%. |
| Non-Organic Solvent | 40-97% |
| Wetting Agent | 0.01-5%. |

8. The cleaning composition as defined in claim 6, comprising by weight percent:

| | |
|---|---|
| Silicone | 0.1-20% |
| Lubricating Agent | 0-25%. |
| Non-Organic Solvent | 40-97% |
| Wetting Agent | 0.01-5%. |

9. The cleaning composition as defined in claim 1, comprising by weight percent:

| | |
|---|---|
| Silicone | 0.5-15% |
| Lubricating Agent | 0.2-15%. |
| Non-Organic Solvent | 60-95% |
| Wetting Agent | 0.05-3.5%. |

10. The cleaning composition as defined in claim 6, comprising by weight percent:

| | |
|---|---|
| Silicone | 0.5-15% |
| Lubricating Agent | 0.2-15%. |
| Non-Organic Solvent | 60-95% |
| Wetting Agent | 0.05-3.5%. |

11. The cleaning composition as defined in claim 1, comprising by weight percent:

| | |
|---|---|
| Silicone | 1-5% |
| Lubricating Agent | 0.5-12%. |
| Non-Organic Solvent | 81-92% |
| Wetting Agent | 0.15-2%. |

12. The cleaning composition as defined in claim 6, comprising by weight percent:

| | |
|---|---|
| Silicone | 1-5% |
| Lubricating Agent | 0.5-12%. |
| Non-Organic Solvent | 81-92% |
| Wetting Agent | 0.15-2%. |

13. The cleaning composition as defined in claim 1, comprising by weight percent:

| | |
|---|---|
| Lubricating Agent | 0.15-15% |
| Silicone | 2-5% |
| Surfactant | 0.05-0.7% |
| Thickening Agent | 0.005-0.5% |
| Non-Organic Solvent | 80.5-92% |
| Organic Solvent | 5-18% |
| pH Buffer | 0.1-0.7% |
| Silicon Emulsion | 0.3-1.5% |
| Wetting Agent | 0.03-1.75% |
| Biocide | 0.02-0.4% |
| Fragrance/Colorant | 0-0.4% |

14. The cleaning composition as defined in claim 6, comprising by weight percent:

| | |
|---|---|
| Lubricating Agent | 0.15-15% |
| Silicone | 2-5% |
| Surfactant | 0.05-0.7% |
| Thickening Agent | 0.005-0.5% |
| Non-Organic Solvent | 80.5-92% |
| Organic Solvent | 5-18% |
| pH Buffer | 0.1-0.7% |
| Silicon Emulsion | 0.3-1.5% |
| Wetting Agent | 0.03-1.75% |
| Biocide | 0.02-0.4% |
| Fragrance/Colorant | 0-0.4% |

15. The cleaning composition as defined in claim 1, comprising by weight percent:

| | |
|---|---|
| Isopar L | 7-12% |
| 350 Silicone Fluid | 2-4% |
| TOFA Surfactant | 0.2-0.5% |
| Poly Gel DR | 0.01-0.25% |
| Water | 82-88% |
| Di-isopropanolamine | 0.3-0.6% |
| SEM 206 | 0.6-1.2% |
| EW-20 | 0.05-0.15% |
| EB Glycol Ether | 0.5-1.2% |
| Nuosept-95/Kathon | 0.04-0.3% |
| Fragrance/Colorant | 0.01-0.2% |

16. The cleaning composition as defined in claim 6, comprising by weight percent:

| | |
|---|---|
| Isopar L | 7-12% |
| 350 Silicone Fluid | 2-4% |
| TOFA Surfactant | 0.2-0.5% |
| Poly Gel DR | 0.01-0.25% |
| Water | 82-88% |
| Di-isopropanolamine | 0.3-0.6% |
| SEM 206 | 0.6-1.2% |
| EW-20 | 0.05-0.15% |
| EB Glycol Ether | 0.5-1.2% |
| Nuosept-95/Kathon | 0.04-0.3% |
| Fragrance/Colorant | 0.01-0.2% |

17. A method of cleaning a hard surface and to form a shine of the hard surface comprising:
a) applying a lubricating based cleaning composition to a hard surface, said cleaning composition including silicone, wetting agent, lubricating agent and non-organic solvent;
b) waiting a period of time to allow said cleaning composition to at least partially wet foreign material on said hard surface; and,
c) at least partially remove said cleaning composition from said hard surface by use of an absorbent material.

18. The method as defined in claim 18, wherein said step of applying said cleaning composition includes a manually powered sprayer, an electric powered sprayer, or an air powered sprayer.

19. The method as defined in claim 18, wherein said sprayer is an electric power sprayer that can apply a generally even coating of said cleaning composition on at least a portion of said hard surface.

20. The method as defined in claim 19, wherein said sprayer is an electric power sprayer that can apply a coating of said cleaning composition on at least a portion of said hard surface at a generally constant force.

21. The method as defined in claim 17, wherein said hard surface is not pre-wetted or pre-washed with water prior to applying said cleaning composition on said hard surface.

22. The method as defined in claim 17, wherein said time period is at least about 1 second.

23. The method as defined in claim 21, wherein said time period is at least about 1 second.

24. The method as defined in claim 22, wherein said time period is less than about 5 minutes.

25. The method as defined in claim 24, wherein said time period is less than about 2 minutes.

26. The method as defined in claim 17, wherein said adsorbent material includes a paper towel, a cloth towel, a sponge, a rag, or combinations thereof.

27. The method as defined in claim 23, wherein said adsorbent material includes a paper towel, a cloth towel, a sponge, a rag, or combinations thereof.

28. The method as defined in claim 17, including the step of enhancing a shine on the hard surface by rubbing the hard surface with a micro-fiber cloth after said cleaning composition has been at least partially removed from the hard surface.

29. The method as defined in claim 28, including the step of enhancing a shine on the hard surface by rubbing the hard surface with a micro-fiber cloth after said cleaning composition has been at least partially removed from the hard surface.

30. The method as defined in clam 17, wherein said cleaning composition is absent wax.

31. The method as defined in claim 17, wherein said cleaning composition includes a lubricating agent other than silicone.

32. The method as defined in claim 17, wherein said non-organic solvent includes water, said water present in an amount of over 80 weight percent of said cleaning composition.

33. The method as defined in claim 17, comprising by weight percent:

| | |
|---|---|
| Silicone | 0.1-20% |
| Lubricating Agent | 0-25%. |
| Non-Organic Solvent | 40-97% |
| Wetting Agent | 0.01-5%. |

34. The method as defined in claim 17, comprising by weight percent:

| | |
|---|---|
| Silicone | 0.5-15% |
| Lubricating Agent | 0.2-15%. |
| Non-Organic Solvent | 60-95% |
| Wetting Agent | 0.05-3.5%. |

35. The method as defined in claim 17, comprising by weight percent:

| | |
|---|---|
| Silicone | 1-5% |
| Lubricating Agent | 0.5-12%. |
| Non-Organic Solvent | 81-92% |
| Wetting Agent | 0.15-2%. |

36. The method as defined in claim 17, comprising by weight percent:

| | |
|---|---|
| Lubricating Agent | 0.15-15% |
| Silicone | 2-5% |
| Surfactant | 0.05-0.7% |
| Thickening Agent | 0.005-0.5% |
| Non-Organic Solvent | 80.5-92% |
| Organic Solvent | 5-18% |
| pH Buffer | 0.1-0.7% |
| Silicon Emulsion | 0.3-1.5% |
| Wetting Agent | 0.03-1.75% |
| Biocide | 0.02-0.4% |
| Fragrance/Colorant | 0-0.4% |

37. The method as defined in claim 17, comprising by weight percent:

| | |
|---|---|
| Isopar L | 7-12% |
| 350 Silicone Fluid | 2-4% |
| TOFA Sufactant | 0.2-0.5% |
| Poly Gel DR | 0.01-0.25% |
| Water | 82-88% |
| Di-isopropanolamine | 0.3-0.6% |
| SEM 206 | 0.6-1.2% |
| EW-20 | 0.05-0.15% |
| EB Glycol Ether | 0.5-1.2% |
| Nuosept-95/Kathon | 0.04-0.3% |
| Fragrance/Colorant | 0.01-0.2% |

38. The cleaning composition as defined in claim 6, comprising by weight percent:

| | |
|---|---|
| Isopar L | 7-12% |
| 350 Silicone Fluid | 2-4% |
| TOFA Sufactant | 0.2-0.5% |
| Poly Gel DR | 0.01-0.25% |
| Water | 82-88% |
| Di-isopropanolamine | 0.3-0.6% |
| SEM 206 | 0.6-1.2% |
| EW-20 | 0.05-0.15% |
| EB Glycol Ether | 0.5-1.2% |
| Nuosept-95/Kathon | 0.04-0.3% |
| Fragrance/Colorant | 0.01-0.2% |
